(19) United States
(12) Patent Application Publication
(10) Pub. No.: US 2016/0034422 A1
(43) Pub. Date: Feb. 4, 2016

(54) Technique for Non-Destructive Testing

(71) Applicant: Airbus Operations GmbH, Hamburg (DE)

(72) Inventor: Carsten Brandt, Hamburg (DE)

(21) Appl. No.: 14/810,659

(22) Filed: Jul. 28, 2015

(30) Foreign Application Priority Data
Jul. 31, 2014 (DE) 102014011424.4

(51) Int. Cl. G06F 17/15

(52) U.S. Cl. CPC G06F 17/153

(57) ABSTRACT

A technique for analyzing a time series obtained or obtainable by Non-Destructive Testing of a sample. The Non-Destructive Testing includes inducing an excitation in the sample and receiving a response to the excitation from the sample. As to a device aspect of the technique, a determining unit determines a trajectory in a state space having dimension n, wherein n is equal to or greater than 2. The trajectory includes a sequence of points in the state space, each point being derived from a subset of the time series. A comparing unit compares the determined trajectory with one or more reference trajectories. An assessing unit assesses a property of the sample based on the comparison.

### CROSS-REFERENCES TO RELATED APPLICATIONS

This application claims the benefit of the German patent application No. 10 2014 011 424.4 filed on Jul. 31, 2014, the entire disclosures of which are incorporated herein by way of reference.

### BACKGROUND OF THE INVENTION

The present disclosure relates to Non-Destructive Testing of a sample. More specifically, and without limitation, a technique for analyzing data obtained by means of Non-Destructive Testing is provided.

Non-destructive testing allows detecting defects of various types and sizes and determining their properties. Conventional techniques for Non-Destructive Testing of samples, such as fiber reinforced plastics, include ultrasonic and thermographic testing. The article “Efficiency of two Non-Destructive Testing methods to detect defects in polymeric materials” by L. Wierzbicki et al., Journal of Achievements in Materials and Manufacturing Engineering, volume 38, issue 2, pages 163-170, describes such conventional techniques. In ultrasonic Non-Destructive Testing, performed in pulse-echo mode, an ultrasonic pulse passes through the sample and is reflected from the opposite surface of the sample. Defects within the sample partially reflect, absorb or scatter the pulse so that a pulse-echo reflected from the opposite sample surface of the sample is reduced, if a defect is present. Large defects (e.g., large compared to the ultrasonic beam) also produce a further direct echo, which can be evaluated.

A conventional analysis of echo data detects a large defect based on its direct echo. However, for smaller defects, the analysis is based on the amplitude of the echo corresponding to the opposite surface of the sample. The defect is detected, if the amplitude of the echo falls below a threshold.

However, the conventional analysis largely ignores information included in the echo data. Even if further echoes, e.g., corresponding to a potential defect, are analyzed for determining a depth location or for estimating a size of the potential defect, the conventional approach for analyzing echo data remains incomplete, since only selected portions of the echo data are taken into account. Furthermore, the analysis relies upon assumptions, e.g., as to a relation between echo delay and the location of the potential defect or as to a relation between the size of the defect and the reflectivity of the defect.

### SUMMARY OF THE INVENTION

Accordingly, there is a need for a technique that reveals more properties of a sample or that more accurately reveals the properties of the sample from Non-Destructive Testing in at least some situations.

According to one aspect, a method of analyzing a time series is provided. The time series is obtained or obtainable by Non-Destructive Testing of a sample. The Non-Destructive Testing includes inducing an excitation in the sample and receiving a response to the excitation from the sample. The method comprises the step of determining a trajectory in a state space having dimension n, wherein n is equal to or greater than 2, and wherein the trajectory includes a sequence of points in the state space, each point being derived from a subset of the time series; a step of comparing the determined trajectory with one or more reference trajectories; and a step of assessing a property of the sample based on the comparison.

The response may include one or more reflections of the induced excitation. The Non-Destructive Testing may include an ultrasonic pulse-echo testing or eddy-current testing. The excitation may be non-guided. For example, the induced excitation may propagate in the sample without being guided by a geometry of the sample and/or boundaries of the sample.

For each of the one or more reference trajectories, the comparison may result in a similarity measure indicative of the similarity between the measured trajectory and the corresponding reference trajectory. The assessment may include sorting the reference trajectories, e.g., according to the similarity measure.

For example, the comparison of a measured trajectory, m, and a reference trajectory, r, may provide the similarity measure:

similarity measure=<m|r>.

A set of reference trajectories, r₁, r₂, r₃, . . . may be stored. The assessment may include accessing the stored reference trajectories and computing the corresponding similarity measure for each reference trajectory in the set of reference trajectories.

The set of reference trajectories, r₁, r₂, r₃, . . . may be mutually exclusive in terms of the similarity measure. For example,

<rᵢ|rⱼ>=0, if i≠j for i,j=1,2,3, . . . .

Furthermore, the assessment may include normalizing the similarity measures, e.g., according to:

Sⱼ=<m|rⱼ> for j=1,2,3, . . . ; and

sⱼ=Sⱼ/(ΣᵢSᵢ) for j=1,2,3, . . . .

The assessment may further include outputting the normalized similarities, sⱼ, e.g., as percentage values:

sⱼ·100%.

The similarity measure may be non-linear, i.e., <α·m|r>≠α·<m|r> for some positive number α.

The property of the sample may be related to an imperfection in the sample and/or an intrinsic material property of the sample. The imperfection may relate to absence, presence and/or an amount of defects in the sample. The intrinsic material property may relate to mass density or elasticity of the sample. Defects may include one or more delaminations, e.g., in Fiber-Reinforced Plastics (FRPs), pores or porosity, e.g., in FRPs or in metallic materials, or cracks in metallic materials.

The time series may include a plurality of data elements. Each data element may be associated with a different instant of time and/or a different measurement event. Each data element may result from a measurement taken at substantially one instant of time. The time series, e.g., each data element thereof, may represent a scalar value. The time series may represent voltage values.

The dimension of the state space may be equal to or greater than 2, 3, 4, 5, 6. A metric may be defined in the state space. The state space may be a linear space. The state space may be a Banach space.

Each point of the trajectory may be associated with one point in time. The response may be the response of a dynamical system. The dynamical system may include a transmitter adapted for inducing the excitation into the sample. The dynamical system may include the sample. The dynamical system may include a receiver adapted to receive the response from the sample. Transmitter and receiver may be collocated or may be one identical means (which may be referred to as a transceiver). Transmitter and receiver may be arranged on or may abut on a surface of the sample. Alternatively or in combination, transmitter and/or receiver may be spaced apart from the sample for the Non-Destructive Testing. For example, transmitter and/or receiver may be immersed in a fluid volume (e.g., in a water container) together with the sample, or transmitter and/or receiver may be coupled to the sample via a free jet (e.g., a water jet). Transmitter and/or receiver may include a squirter directed or directable towards the sample. An exemplary ultrasonic squirter is described in European patent application EP 0444578 A2. Each point may represent a state of the dynamical system. The trajectory may represent a time evolution of the dynamical system.

The subset may be defined by a time window. The sequence of points may result from shifting the time window along the time series. The subset may include more than one data element of the time series. The time window may define the subset as those data elements that are associated with an instant of time that falls within the time window.

A size of the time window may be shorter than a propagation time between the excitation and the response. For example, the size of the time window may be a fraction of the propagation time. A size of the time series may be equal to or shorter than the propagation time.

The propagation time may be defined as the time elapsed since the excitation and until signal strength of the response starts decreasing or has decreased to a predefined fraction of a peak. The sample may have a length, e.g., in a direction of propagation for the induced excitation or in a direction normal to an interface of the sample at which interface the excitation is induced or reflected. The excitation may propagate along the length. Alternatively or in addition, the propagation time may be defined as the time for the propagation along the length and/or through the sample, e.g., so as to traverse the entire sample once or twice.

The sample may be excited by pulses. The sample may be periodically excited, e.g., by means of the pulses. The excitation may include ultrasound traversing the sample. The excitation may be induced at a first interface of the sample. The excitation may be substantially absorbed at a second interface of the sample opposite to the first interface. The response may be caused by scattering the excitation at inhomogeneities located between the first interface and the second interface.

Alternatively or in addition, the excitation may include eddy currents induced in the sample. The eddy currents may be induced by a coil. The response may be measured by the same or another coil. The response may be represented as an impedance of the coil or a change of the impedance. The impedance may be represented in the complex plane.

The subset may include at least n data elements of the time series. Neighboring data elements may be separated by a time lag. The time lag may correspond to a first zero crossing of an auto-correlation function of the time series. Alternatively or in addition, the time lag may correspond to a first minimum of mutual information between neighboring data elements of the time series.

The coordinates of the points in the state space of dimension n may be represented by the different data elements in the subset. For example, a first data element may define the point in a first dimension, a second element of the subset may define the point in a second dimension, and so forth up to an n-th element in the subset defining the point in an n-th dimension of the state space.

The time series may be obtained by Non-Destructive Testing of a first portion of the sample. At least one of the one or more reference trajectories may result from Non-Destructive Testing of a second portion of the sample. The second portion may be spaced apart from the first portion. Alternatively or in addition, at least one of the one or more reference trajectories may result from Non-Destructive Testing of a reference sample separated from the sample. The reference sample may be not integral with the sample.

At least one of the one or more reference trajectories may result from a simulation of the Non-Destructive Testing. The at least one of the one or more reference trajectory may be simulated assuming a sample free of defects. Alternatively or in addition, one or more of the reference samples may be simulated assuming a sample with one or more defects. For example, the simulation may assume different numbers of defects, different sizes of the defects, different shapes of the defects and/or two or more different locations for the one or more defects in the sample. The property may be indicative of number, size, shape and/or location of defects in the sample.

The trajectory may include or approximate an attractor in the state space. The attractor may define or occupy a closed and/or connected subset of the state space. The attractor may represent a stationary state of the dynamical system. The dynamical system may approach the attractor, e.g., substantially independent of initial conditions of the Non-Destructive Testing. The attractor may be embedded in the state space.

The attractor may exhibit a dimension d. The dimension of the state space, n, may be equal to or greater than 2d.

The comparison and/or the assessment may result in a single number. The comparison may include evaluating, e.g., for each point of the sequence, a metric between the point of the determined trajectory and a corresponding point of the one or more reference trajectories. Optionally, the comparison further includes summing up the evaluations of the metric or a function thereof.

Alternatively or in addition, the comparison may include evaluating a number of coinciding points in a cross recurrence plot between the determined trajectory and one or more reference trajectories. The cross recurrence plot may be a two-dimensional representation of the coinciding points. A first point of the determined trajectory and a second point of the one or more reference trajectories may coincide, if the metric between the first point and the second point is below a threshold. The evaluation does not have to expressly compute the cross recurrence plot (e.g., as an intermediate result).

According to another aspect, a computer program product is provided. The computer program product may comprise instructions for performing one or more of the steps of the method aspect when the computer program product is executed by one or more computing devices. The computer program product may be encoded on a computer-readable recording medium and/or may be provided for download to such a medium via a data network, e.g., the Internet.

According to a hardware aspect, a device for analyzing a time series is provided. The time series is obtained or obtainable by Non-Destructive Testing of a sample. The Non-Destructive Testing includes inducing an excitation in the sample and receiving a response to the excitation from the sample. The device comprises a determining unit adapted to determine a trajectory in a state space having dimension n, wherein n is equal to or greater than 2, and wherein the trajectory includes a sequence of points in the state space, each point being derived from a subset of the time series; a comparing unit adapted to compare the determined trajectory with one or more reference trajectories; and an assessing unit adapted to assess a property of the sample based on the comparison.

The device may further include any feature disclosed in the context of the method aspect. The device, e.g., any one of the units or a dedicated unit, may further be adapted to perform any one of the steps of the method aspect.

According to a still further aspect, a system for Non-Destructive Testing is provided. The system includes a testing device adapted to perform the Non-Destructive Testing and the device for analyzing a time series. The testing device may include at least one of a transmitter, a receiver and a transceiver.

### BRIEF DESCRIPTION OF THE DRAWINGS

In the following, the present disclosure is described in more detail with reference to exemplary embodiments illustrated in the drawings, wherein:

FIG. 1 schematically illustrates a setup for ultrasonic Non-Destructive Testing of a sample;

FIG. 2 schematically illustrates echo-pulses resulting from ultrasonic Non-Destructive Testing in the presence of a defect;

FIG. 3 schematically illustrates a setup for ultrasonic Non-Destructive Testing of a sample with internal structure;

FIG. 4 shows a schematic block diagram of a device for analyzing a time series obtained by Non-Destructive Testing;

FIG. 5 schematically illustrates an exemplary time series obtained by Non-Destructive Testing;

FIG. 6 schematically illustrates an exemplary state space representation resulting from the time series; and

FIG. 7 schematically illustrates a comparison between a measured trajectory and a reference trajectory.

### DETAILED DESCRIPTION OF THE PREFERRED EMBODIMENTS

In the following description, for purposes of explanation and not limitation, specific details are set forth, such as specific measurement environments and specific functions for analyzing measurement data in order to provide a thorough understanding of the technique disclosed herein. It will be apparent to one skilled in the art that the technique may be practiced in other embodiments that depart from these specific details. While the following embodiments are primarily described in the context of ultrasonic Non-Destructive Testing (NDT), it will be readily apparent that the technique described herein may also be applied for analyzing and evaluating data resulting from any other NDT, including thermography (e.g., by imaging of the thermal patterns at a surface of a sample) and eddy-current testing (e.g., using electromagnetic induction to detect flaws in conductive materials).

Moreover, those skilled in the art will appreciate that the functions, steps and units explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while embodiments are described in context with methods and devices, the invention may also be embodied in a computer program product as well as in a system comprising a computer processor and memory coupled to the processor, wherein the memory is encoded with one or more programs that may perform the functions, steps and implement the units disclosed herein.

NDT is also referred to as non-destructive inspection. The analysis of measurement data is also referred to as evaluation. Data resulting from NDT is also referred to as a response signal. Implementing NDT in a process for detecting and/or characterizing damage at an engineering structure with permanently installed transceivers, or permanently installed transmitters and receivers, is also referred to as Structural Health Monitoring (SHM). The sample is also referred to as material or part to be tested.

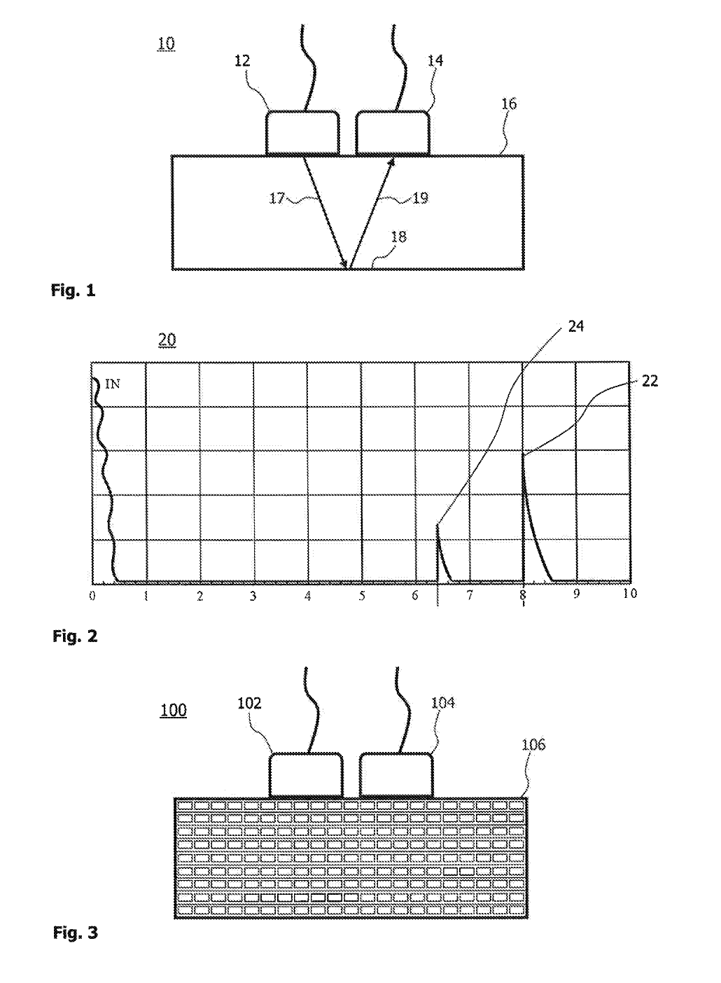

FIG. 1 schematically illustrates a setup 10 for NDT. A transmitter 12 induces an excitation into a sample 16. As indicated at reference sign 17, the excitation propagates within the sample 16 to a back surface 18. The excitation is partially reflected from the back surface 18 and propagates further within the sample 16 at reference sign 19. A receiver 14 detects the reflection as a response to the excitation. In the context of ultrasonic NDT, the response is also referred to as an echo.

A conventional evaluation of data resulting from NDT, e.g., ultrasonic NDT or eddy-current NDT, is often based on one or few scalar quantities. An operator

or a (semi-)automated device determines whether a predefined portion in the signal, e.g., ultrasonic echoes or an electromagnetic impedance, exceeds a certain threshold to decide whether the signal is to be reported as a potential defect or not. The potential defect is also referred to as an indication.

The transmitter 12 and the receiver 14 may be integrated into a mobile transceiver head or may be permanently installed, e.g., for SHM, at the engineering structure, preferably using a propagation of the excitation that is not guided as the excitation (e.g., wave) traverses the sample. Furthermore, the transmitter 12 and the receiver 14 may be identical and operated simultaneously in, or alternatingly between, a transmitting and receiving mode (e.g., using a piezoelectric transceiver).

FIG. 2 schematically illustrates a response signal, as a function of time, obtainable from ultrasonic NDT. The excitation is induced at time 0, i.e., the horizontal time axis indicates the delay of the response. The response includes a main echo 22 corresponding to the reflection at the back surface 18. A defect, e.g., a crack or inhomogeneity, along the propagation path 17 causes a further echo 24 (intermediate echo) that is smaller than the main echo 22.

Since some defects, e.g., porosity, do not cause a clear intermediate echo (such as the ideal intermediate echo 24 illustrated in FIG. 2), a conventional analysis determines, in addition to intermediate echoes 24, the main echo 22, e.g., as a maximum in the response. Since the main echo 22 is indicative of a residual of the excitation after traversing the sample 16, the amplitude of the main echo 22 decreases in the presence of a defect. Hence, the conventional analysis tries to detect the presence of defects, which do not cause an echo as clear as the ideal intermediate echo 24, based on the main echo 22 falling below a certain threshold.

However, it is often not possible to rely upon the back-surface reflection. FIG. 3 schematically illustrates a setup 100 for NDT that is similar to the setup 10. Reference signs with corresponding last digit indicate corresponding features in FIGS. 1 and 3. A sample 106 has a complex internal structure, e.g., a pocket structure in Carbon Fiber Reinforced Polymers (or Carbon Fiber Reinforced Plastics, CFRP). The induced pulse is essentially absorbed by the plurality of pockets so that a pulse-echo corresponding to the back-surface reflection cannot be determined as a maximum in the response.

Other situations in which it is not possible to rely upon the back-surface reflection include arrangements, in which several structures are bonded together and the bondline does not provide a homogenous interface for producing a defined ultrasonic echo, or a sandwich structure, in which a core (e.g., a honeycomb paper or foam) is at the top and the bottom covered with CFRP.

Independent of the NDT implementation, the NDT setup 100 (e.g., an NDT equipment 102, 104 and the sample 106 being tested) form a complex system. The response resulting from the NDT includes complex data, e.g., waveforms, containing information that cannot be evaluated by conventional analysis methods.

One example for complexity is the influence of porosity in CFRP on the signal of ultrasonic pulse-echo inspection. CFRP with such complex internal structure are used in automotive and aircraft engineering. For example, the Airbus A350XWB includes complex CFRP parts. Complexity may further be due to an external geometry of the sample 106, e.g., a T-joint made from metal under ultrasonic NDT causing a dense set of propagation paths, e.g., due to multiple reflections at curved surfaces. Another example for complexity includes an inhomogeneity deliberately present in the sample 106, e.g., layers of a laminate. A further example for dynamical complexity includes the mechanical interaction of an ultrasonic sound wave with a delamination as a defect in the sample 106. A still further example for complex dynamics includes the interaction of a crack in a metal, e.g., aluminum. The crack can interrupt an eddy current induced by the NDT.

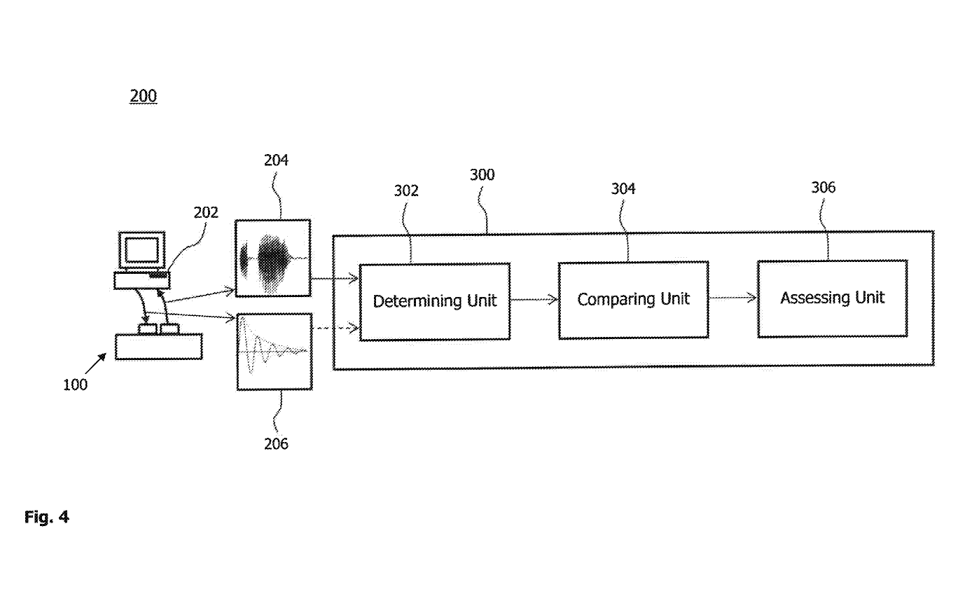

FIG. 4 schematically illustrates an NDT system 200. The NDT system 200 includes the NDT equipment 100 and a device 300 for analyzing a time series 204 obtained from the NDT.

The device 300 includes a determining unit 302, a comparing unit 304 and an assessing unit 306. The determining unit 302 determines a representation of the dynamics of the complex system under the excitation. The dynamics is represented in a state space based on the time series 204 and, optionally, an excitation signal 206 used by the NDT equipment 100 for inducing the excitation in the sample 106. The comparing unit 304 compares the state space representation with a reference representation in the state space. Based on the comparison, the assessing unit 306 determines a property of the sample 106, e.g., the presence of a critical defect in the sample 106.

The units 302 to 306 may be implemented in a computer system 202.

At least some embodiments of the device 300 improve the evaluation of waveform data resulting from the NDT 100. Same or other embodiments of the device 300 provide information out of the NDT data which cannot be extracted by conventional analysis methods. The technique is applicable for an evaluation of data from NDT of parts made from CFRP, metals or other materials. The technique can, e.g., depending on the implementation, detect and characterize defects or other material properties.

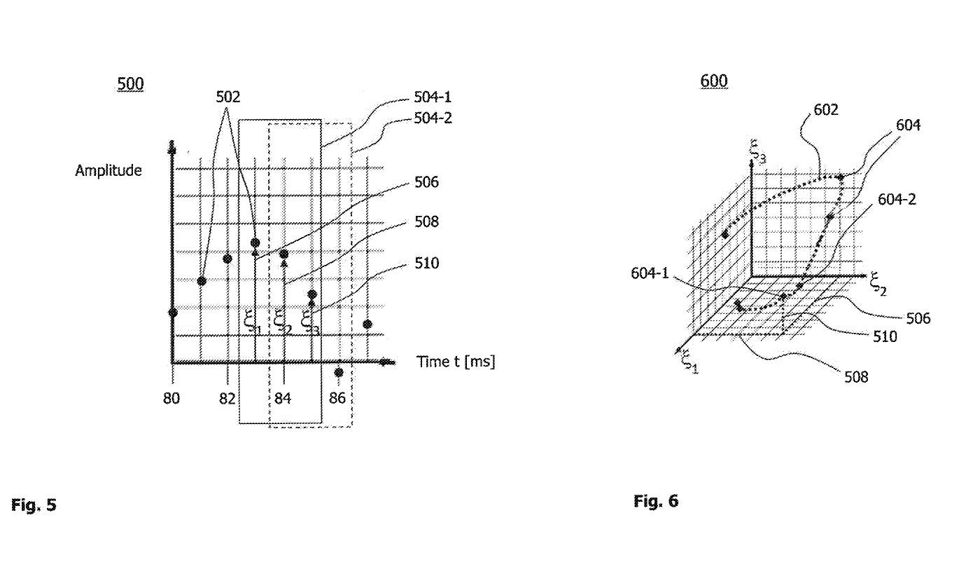

An exemplary implementation of the determining unit 302 is descripted with reference to FIG. 5. An excerpt 500 of the time series 204 includes a plurality of data elements 502. In the exemplary implementation, the each of the data elements 502 represents a real-valued amplitude of the time series 204 at a certain point in time. For example, the amplitude of the waveform is shown on the vertical axis in FIG. 5. Time is shown on the horizontal axis. The data elements 502 result from down-sampling the response sampled at a frequency of, e.g., about 100 MHz for ultrasonic NDT, e.g., using ultrasonic pulses in the range of 2 to 10 MHz.

In a first variant, the data elements 502 represent an envelope function (e.g., a magnitude of the amplitude or a non-negative magnitude of the amplitude). In a second variant, the data elements 502 represent a complex-valued amplitude, e.g., including phase information of the response.

The determining unit 302 reconstructs a representation in a multidimensional state space 600 shown in FIG. 6 out of the NDT time series 204, e.g., the waveform data. The time series 204 represents the dynamics of a non-linear dynamical system including the sample 106 under the NDT excitation. The determined state space representation represents the dynamics implied by the NDT response. The representation is different for different material properties or defects of the sample 106 and, thus, can give information about the property, which cannot be extracted by a conventional evaluation.

For example, the NDT equipment 102, 104 and the sample 106 being tested form a dynamical system. The response of the dynamical system is a nonlinear function of the excitation. The waveform data 204 read into the device 300 is generated by the NDT equipment 100 due to the interaction with the material and potential defect of the sample 106 under test. The data 206 of the excitation signal transmitted into the sample 106 (e.g., an initial pulse or surface echo of an ultrasonic pulse-echo inspection) may be used additionally, e.g., for computing a response function as a time series 204 corresponding to an ideal excitation pulse.

The state space 600 has a dimension n, e.g., equal to 3. The exemplary implementation of the determining unit 302 reads in the time series 204, e.g., the waveform data, resulting from any NDT method. The determining unit 302 includes a function or several functions, which reconstruct values of n coordinates, which represent the dynamical system, e.g., the excitation dynamics as a function of time, out of the one-dimensional response 204, which is available in the form of the measured waveform.

In the exemplary implementation of FIG. 5, a time window 504 determines a subset of the data elements 502. The size of the time window 504 corresponds to n data elements 502. The values indicated at reference signs 506, 508 and 510 of the n data elements within the instance 504-1 of the time window 504 specify one point 604-1 in the state space 600. The time window 504 is shifted, e.g., by one data element 502 to a later point in time, as is illustrated at reference sign 504-2. The n determined data elements out of the data elements 502 defined by the shifted time window 504-2 specify a further point 604-2 in the state space 600. The sequence of points 600 resulting from shifting the time window 504 form a measured trajectory 602 in the state space 600.

The state space reconstruction may be subject to the condition that the dynamical system represented in the state space 600 is non-linear, e.g., chaotic. Herein, chaotic may be defined as a non-linear dependency of the response as a function of the excitation. While above exemplary implementation uses a discrete time series 204, the state space representation may treat the dynamical system as a continuous dynamical system.

The measured trajectory 602 may represent or approximate an attractor or other features of a phase portrait that sufficiently characterizes the dynamical system, e.g., to distinguish an excitation dynamic with and without defects.

The state space reconstruction is also referred to as embedding. Means for detecting attractors in the time series 204 are described in the article “Detecting strange attractors in turbulence”, by F. Takens, Springer 1981, pages 366-381; and in the book “Nonlinear Time Series Analysis”, by H. Kantz and T. Schreiber, Univ. Press 2005.

Furthermore, the sample 106 may refer to the material, a part, or an area of the part, e.g., in terms of the dynamical system defined by the sample 106 and the NDT equipment 102, 104. For example, different materials, different parts, or different areas of the same part may define different dynamical systems represented by different trajectories 602.

An implementation of a method for analyzing a time series obtained or obtainable by NDT of a sample uses one-dimensional waveform data for reconstructing a representation in an n-dimensional state space with n>1, e.g., under the assumption that an NDT response represented by the time-series is not linear in an NDT excitation. Information is extracted out of the state space representation for detecting and characterizing defects and/or material properties.

The comparing unit 304 performs a numerical comparison of the measured state space representation with a predetermined reference representation, e.g., information about reference areas or reference parts without and/or with defects, or with different material properties, respectively.

A first example of the reference representation is based on information resulting from an NDT of a reference sample, e.g., a reference material, including defect-free areas as well as areas with different kinds and sizes of defects or different material properties. The reference representation results from an NDT of the reference sample using the same NDT equipment 102, 104. The reference representation allows determining different behavior of the dynamical system in the state space 600 (e.g., determining that the tested sample defines a different dynamical system). The excitation may be selectively induced into different portions of the measured sample 106 and/or different portions of the reference sample for assessing different properties of different portions.

A second example of the reference representation is based on a simulation of the behavior of the dynamical system, e.g., in dependence of defects and/or material properties.

Based on the comparison, the assessing unit 306 outputs a result as to presence of defects and/or material properties of the sample 106. For example, the assessing unit 306 outputs the reference state space representation, or an identifier thereof, that is most similar to the measured state space representation according to the comparison.

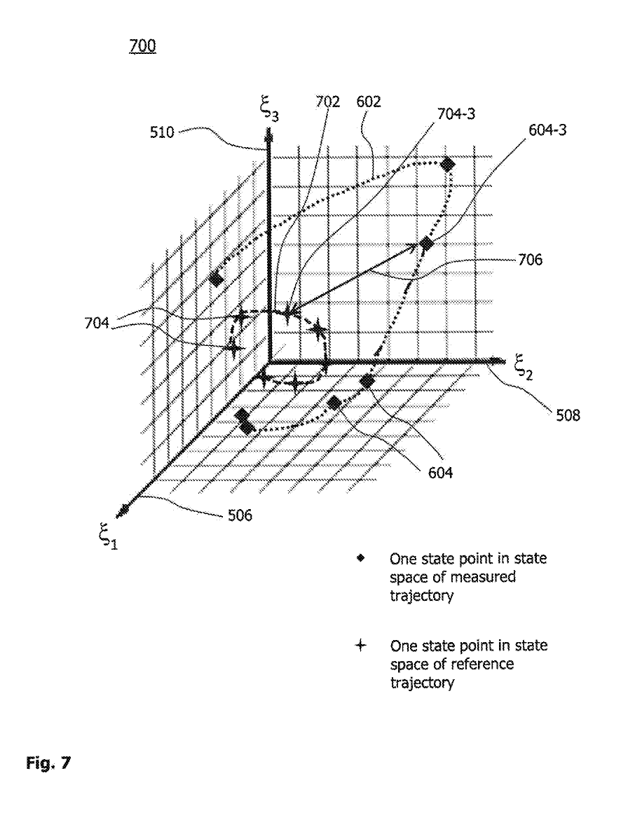

An exemplary implementation of the comparing unit 304 is described with reference to FIG. 7. FIG. 7 schematically illustrates trajectories in a state space 700, e.g., a temporal sequence of state points in the state space. A reference trajectory 702 includes reference points 704 in the state space 700.

A metric 706 is defined in the state space 700. The metric assigns a positive number to a pair of points, e.g., points 604-3 and 704-3 of the measured trajectory 602 and the reference trajectory 702, respectively, corresponding to equal points in time. The exemplary state point 604-3 of the measured trajectory 602 is compared with a corresponding reference state point 704-3 of the reference trajectory 702 by evaluating the metric 706. The metric may be a Euclidean distance or a generic metric based on a norm ∥x_{measured}−x_{reference}∥. For example, the difference is computed for each of the n coordinates and the metric is the maximum difference of the n coordinate differences. In a variant, the metric is the average of the n coordinate differences.

The norm may be based on an inner product.

The metric is evaluated for each pair of corresponding points. The resulting plurality of metric values is combined, e.g., by summation (for example by summing up the square of each of the metric values) or by averaging.

Alternatively or in addition, the comparison may include a nonlinear cross prediction error, e.g., as described in the thesis “Time Series Analysis and Feature Extraction Techniques for Structural Health Monitoring Applications”, by L. A. Overbey, University of California, San Diego 2008, Sect. 2.2.2

Alternatively or in further addition, the comparison may include differential features resulting from a cross recurrence plot, e.g., based on the recurrence plot described in the thesis “Analysis and modeling of diffuse ultrasonic signals for Structural Health Monitoring”, by Y. Lu, Georgia Institute of Technology, 2007, Sect. 5.4. For example, the cross recurrence plot may be computed according to

CR_{i,j}=1, if ∥x_{measured}(i)−x_{reference}(j)∥<ε,otherwise CR_{i,j}=0,

evaluated at discretized times i and j of the measured trajectory 602 and the reference trajectory 702, respectively. Herein, the positive number ε is a threshold for the metric value.

The plurality of values of the cross recurrence is combined by summation:

Result of comparison=ΣᵢΣⱼCR_{i,j}/N²,

wherein N is the number of state space points in the trajectory 602.

The dimension n of the state space may be determined based on an embedding dimension d of the trajectory 602. The dimension n may be chosen so that n>d, e.g., n=2d or 2d+1. While the state space dimension is an integer number, the embedding dimension may be a fractal dimension. The embedding dimension may be computed using the Minkowski-Bouligand dimension (also referred to as box-counting dimension). Alternatively or in combination, the embedding dimension may be computed using False Nearest Neighbors (FNN) methods described in afore-cited thesis “Time Series Analysis and Feature Extraction Techniques for Structural Health Monitoring Applications” by Overbey in Sect. 2.2.1.2.

A time lag, r, between consecutive data elements 502 may be determined according to a first zero crossing of an auto-correlation function of the time series 204 or a first minimum of the mutual information in the time series 204. Examples for computing time lag r are described in afore-cited thesis “Time Series Analysis and Feature Extraction Techniques for Structural Health Monitoring Applications” by Overbey on page 21. Further criteria for determining the time lag i are described in afore-cited book “Nonlinear Time Series Analysis” by Kantz et al. The time lag t may be realized by a down-sampling rate applied to the time series 204 for computing the data elements 502.

The technique disclosed herein is also applicable to a driven stationary state of the dynamical system, e.g., using periodic driving pulses as the excitation.

As has become apparent from above exemplary embodiments, at least some embodiments improve evaluation of data from NDT, e.g., as to detection and characterization of defects or other material properties. The NDT may include non-permanently installed sensors.

The technique is not limited to a certain NDT method. The NDT may include ultrasonic and electromagnetic excitations. The technique can be applicable with any NDT providing waveform data as an output or as internal data.

Embodiments of the technique can extract information out of data from NDT, which cannot be obtained by conventional approaches and allow conclusions as to defects and material properties otherwise unavailable.

Based on, or due to, the technique, different designs of, for example, CFRP structures can be realized and/or monitored, e.g., since shortcomings of exciting NDT analyses have hindered such advanced designs. The technique can allow simpler or more lightweight designs, e.g., because more information about part quality can be gained.

Furthermore, embodiments of the technique may allow quicker inspection, e.g., because the ability to extract more information may lower the effort for, or avoid, other time-consuming or costly inspections. For example, in some situation, the technique may allow inspections from only one side of a part to be sufficient.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of analyzing a time series obtained or obtainable by Non-Destructive Testing of a sample, wherein the Non-Destructive Testing includes inducing an excitation in the sample and receiving a response to the excitation from the sample, the method comprising:
determining a trajectory in a state space having dimension n, wherein n is equal to or greater than 2, and wherein the trajectory includes a sequence of points in the state space, each point being derived from a subset of the time series;
comparing the determined trajectory with one or more reference trajectories; and
assessing a property of the sample based on the comparison.

2. The method of claim 1, wherein the property is related to at least one of an imperfection in the sample and an intrinsic material property of the sample.

3. The method of claim 1, wherein the subset is defined by a time window and the sequence of points results from shifting the time window along the time series.

4. The method of claim 1, wherein the sample is periodically excited.

5. The method of claim 1, wherein the excitation includes ultrasound traversing the sample.

6. The method of claim 1, wherein the excitation is induced at a first interface of the sample and substantially absorbed at a second interface of the sample opposite to the first interface, and the response is caused by scattering the excitation at inhomogeneities located between the first interface and the second interface.

7. The method of claim 1, wherein the excitation includes eddy currents induced in the sample.

8. The method of claim 1, wherein the subset includes at least n data elements of the time series, which are separated by a time lag.

9. The method of claim 7, wherein the time lag corresponds to a first zero crossing of an auto-correlation function of the time series.

10. The method of claim 7, wherein the time lag corresponds to a first minimum of mutual information between neighboring data elements of the time series.

11. The method of claim 1, wherein the time series is obtained by Non-Destructive Testing of a first portion of the sample, and at least one of the one or more reference trajectories results from Non-Destructive Testing of a second portion of the sample, the second portion being spaced apart from the first portion.

12. The method of claim 1, wherein the time series is obtained by Non-Destructive Testing of a first portion of the sample, and at least one of the one or more reference trajectories results from Non-Destructive Testing of a reference sample separated from the sample.

13. The method of claim 1, wherein at least one of the one or more reference trajectories results from a simulation of the Non-Destructive Testing.

14. The method of claim 1, wherein the trajectory includes or approximates an attractor in the state space,
wherein optionally the attractor has a dimension d, and wherein optionally n is equal to or greater than 2d.

15. The method of claim 1, wherein the comparison includes evaluating for each point of the sequence a metric between the point of the determined trajectory and a corresponding point of the one or more reference trajectories and, optionally, summing a function of the evaluations.

16. The method of claim 1, wherein the comparison includes evaluating a number of coinciding points in a cross recurrence plot between the determined trajectory and one or more reference trajectories.

17. A device for analyzing a time series obtained or obtainable by Non-Destructive Testing of a sample, wherein the Non-Destructive Testing includes inducing an excitation in the sample and receiving a response to the excitation from the sample, the device comprising:
a determining unit adapted to determine a trajectory in a state space having dimension n, wherein n is equal to or greater than 2, and wherein the trajectory includes a sequence of points in the state space, each point being derived from a subset of the time series;
a comparing unit adapted to compare the determined trajectory with one or more reference trajectories; and
an assessing unit adapted to assess a property of the sample based on the comparison.

18. A system for Non-Destructive Testing, comprising
a testing device adapted to perform a Non-Destructive Testing of a sample wherein the Non-Destructive Testing includes inducing an excitation in the sample and receiving a response to the excitation from the sample; and
a device for analyzing a time series obtained by the Non-Destructive Testing, the device comprising:
a determining unit adapted to determine a trajectory in a state space having dimension n, wherein n is equal to or greater than 2, and wherein the trajectory includes a sequence of points in the state space, each point being derived from a subset of the time series;
a comparing unit adapted to compare the determined trajectory with one or more reference trajectories; and
an assessing unit adapted to assess a property of the sample based on the comparison.
